(19) United States
(12) Patent Application Publication
(10) Pub. No.: US 2006/0155094 A1
(43) Pub. Date: Jul. 13, 2006

(54) Wood adhesives

(76) Inventors: Walter Meckel, Dusseldorf (DE); Eduard Mayer, Dormagen (DE); Mathias Wintermantel, Koln (DE)

Correspondence Address: BAYER MATERIAL SCIENCE LLC, 100 BAYER ROAD, PITTSBURGH, PA, 15205, US

(21) Appl. No.: 11/328,275

(22) Filed: Jan. 9, 2006

(30) Foreign Application Priority Data
Jan. 13, 2005 (DE) 102005001565.4

(51) Int. Cl. C08G 18/00

(52) U.S. Cl. 528/44

(57) ABSTRACT

The present invention relates to the use of compositions based on special isocyanate-terminated prepolymers as wood adhesives. The composition comprises at least one isocyanate-terminated prepolymer obtained by reacting at least one organic polyisocyanate and a mixture of at least two organic polyhydroxyl compounds containing at least 20 wt. % of fatty acid triglycerides containing hydroxyl groups, and at least 20 wt. % of polyethers having an average of at least two hydroxyl groups, and optionally auxiliary substances and additives.

### CROSS-REFERENCE TO RELATED APPLICATION

This application claims priority under 35 U.S.C. §119 (a-e) to German application 10 2005001565, filed Jan. 13, 2005.

### FIELD OF THE INVENTION

The present invention relates to the use of compositions, based on special isocyanate-terminated prepolymers, especially as raw materials for the manufacture of coating materials and adhesives, particularly wood adhesives.

### BACKGROUND OF THE INVENTION

Adhesives based on phenol- or resorcinol-formaldehyde or melamine-formaldehyde condensation products are known and are used for bonding wood, especially in the case of highly stressed, durable wood constructions (e.g. EP-A 0 879 270). The reaction of the aqueous hardener mixture with the melamine resin is a polycondensation reaction in which water is released as the polymer is synthesized. For the course of the reaction to be reproducible, the water content of the wood therefore has to satisfy strict conditions.

In the case of highly stressed wood constructions, e.g. load-bearing structural members, high demands are made on the mechanical strength of the structural members. For example, the strength of the joint should still be adequate even after many years of weathering.

The general usability of adhesives is established by satisfying Standards such as DIN EN 204, durability class D4, or WATT 91 (Wood Adhesives Temperature Test).

The bonding of wood with polyurethane adhesives, as both one-component and two-component systems, has been known for a long time and is described in the journal “Adhäsion—Kleben & Dichten”, 41, 1-2/97, pp 37-38 (1997). One-component systems are particularly suitable for wood substrates because the natural moisture content of wood ensures that enough water is available as a reactant. This dispenses with the need to check the exact water content or, as is conventional with many water-impermeable substrates, to spray the substrate surfaces with water mist in order to guarantee a complete reaction.

A disadvantage, however, especially in the case of two-component systems, is that when low-viscosity polyisocyanates are used, they migrate into the wood during the pressing process. Although this produces a good joint between adhesive and wood, excessive migration causes an uncontrolled shift in the NCO—OH ratio of the adhesive mixture in the glue joint, said ratio being important for the synthesis of the polymer. In the case of low-viscosity one-component systems, the glue joint, especially the wood/adhesive interface, becomes depleted in polyisocyanate; under extreme conditions, defective adhesive bonding can occur in both cases.

To guarantee a sufficient concentration of adhesive in the glue joint, it is possible to use higher-viscosity systems, although these present appreciable application problems. Another possibility is to add fillers, suitable examples being organic fillers; mineral fillers are less suitable because they readily tend to form a sediment and, when the adhesive is dispensed by machine, can lead to increased abrasion in the complex pumping and metering systems.

Examples of organic fillers which can be used are wood flour, cellulose fibres and also plastic fibres. Plastic fibres in the form of microfibres additionally act as a thixotropic additive. Particularly suitable fillers are dispersions, prepared in situ, of polyureas and/or polyhydrazodicarboxamides in polyethers containing hydroxyl groups, which are used on a large scale for the production of polyurethane foams of increased crushing strength (e.g. DE-OS 25 13 815).

Flexible adhesive bonds of excellent cohesive strength are obtained, e.g. in DE-OS 27 19 720, using both one-component and two-component polyurethane adhesives based on organic polyisocyanates and dispersions of polymers in organic hydroxyl compounds.

A substantial disadvantage of adhesively bonded wood constructions is the susceptibility of the adhesive to moisture, which leads to a weakening of the adhesive layer and limits the use of adhesively bonded wood constructions in permanently damp environments. Consequently, in the dry state, extensive base part failure of the wood can often be seen, whereas when stored in water, or in the boiling test, cohesive failure can be observed.

EP-A 1 343 832 claims isocyanate-terminated prepolymers as wood adhesives which contain organic fillers based on addition products of toluylene diisocyanate and hydrazine, and hence have a high water resistance.

The ready-to-use adhesives are generally manufactured in two stages.

In the first stage the low-viscosity starting materials, such as polyols and polyisocyanates, are converted to isocyanate-terminated prepolymers in normal stirred tank reactors, which are optimally suitable for such low-viscosity starting materials.

The ready-to-use adhesive is formulated in special stirred units that are more suitable for the incorporation of additives with a tendency to agglomerate, such as rheological processing aids in particular. Stirred tank reactors equipped with Dissolver disks may be mentioned especially here.

A disadvantage of prepolymers that already contain fillers in the first stage is the fact that, in the normal course of production for the manufacture of isocyanate-terminated prepolymers for use in a very wide variety of fields, such filled prepolymers incur high expenditure for cleaning of the production units because, without cleaning, the next batch of prepolymer would no longer be completely transparent in appearance due to the filler from the previous batch, which would make it unusable for many applications.

The object of the present invention was thus to provide a low-viscosity, substantially filler-free isocyanate-terminated prepolymer as the raw material for a one-component wood adhesive, especially for bonding load-bearing structural members, which has an improved water resistance.

### SUMMARY OF THE INVENTION

It has now been found, surprisingly, that fatty acid triglycerides containing hydroxyl groups, especially isocyanate-terminated prepolymers containing castor oil and castor oil derivatives, have a lesser tendency to penetrate the wood and hence, when used in a thin layer to bond wood, even without fillers, have a lesser tendency to exhibit substrate failure. Substrate failure is understood as meaning that the fracture pattern in the glue joint exhibits major or complete wood fracture, whereas in the other cases an adhesive failure, i.e. a smooth fracture at the adhesive/wood interface, or a cohesive failure, i.e. fracture within the adhesive layer, can be observed. Also, such polyols give the bond a high hydrophobicity, which has a positive influence on the properties, especially in a damp environment. In particular, prepolymers obtainable with the concomitant use of polyetherpolyols are found to be especially suitable because this lowers the viscosity of the prepolymers, which improves the wetting of the substrate surface and affords the subsequent adhesive manufacturer a greater degree of flexibility when formulating. Castor oil itself, with a hydroxyl number of approx. 160 to 170 mg KOH/g, imparted too high a viscosity to the prepolymers obtained therewith and proved less suitable in respect of the subsequent processing and compounding. To produce low-viscosity prepolymers in this case, the proportion of polyetherpolyols has to be increased, although this again minimizes the aforementioned advantages. On the other hand, the commercially available mono-dehydrated castor oil with a hydroxyl number of about 100 to 140 mg KOH/g, in particular, was found to be optimal because it gives the adhesive a very good hydrophobicity without contributing excessively to the viscosity increase during the synthesis of the prepolymer, thereby enabling the polyether content to be kept smaller.

The present invention thus provides the use of a composition, containing:

a) at least one isocyanate-terminated prepolymer obtainable by reacting

a1) at least one organic polyisocyanate and

a2) a mixture of at least two organic polyhydroxyl compounds containing:
i) at least 20 wt. % of fatty acid triglycerides containing hydroxyl groups, and
ii) at least 20 wt. % of polyethers having an average of at least two hydroxyl groups,
the amounts given for i) and ii) being based on the total amount of mixture a2), and
   b) optionally auxiliary substances and additives,
   for the manufacture of coating materials and/or adhesives, especially adhesives for bonding wood substrates.

### DETAILED DESCRIPTION OF PREFERRED EMBODIMENTS

As used herein in the specification (including the examples) and claims, and unless otherwise expressly specified, all numbers may be read as if prefaced by the word “about”, even if the term does not expressly appear. Also, any numerical range recited herein is intended to include all sub-ranges subsumed therein.

The mixture a2) preferably has a mean hydroxyl number of the mixture of 50 to 180 mg KOH/g.

The isocyanate-terminated prepolymer a) preferably has an isocyanate (NCO) content of 8 to 20 wt. %, particularly preferably of 10 to 18 and very particularly preferably of 12 to 18 wt. %. The isocyanate content denotes the content of free isocyanate groups, for example as determined according to DIN 53185. Here the prepolymer containing isocyanate groups is reacted with a stoichiometric excess of dibutylamine and the content of isocyanate groups is determined by back titration of the unreacted amount of dibutylamine.

Suitable polyisocyanates for synthesizing the isocyanate-terminated prepolymers a) are the aliphatic, cycloaliphatic, aromatic and heterocyclic polyisocyanates known from polyurethane chemistry, such as those described e.g. by W. Siefken in Justus Liebigs Annalen der Chemie, 562, pages 75 to 136. Other suitable polyisocyanates are those having e.g. isocyanurate, biuret, uretdione or carbodiimide groups. Such polyisocyanates can have high functionalities, e.g. of more than 3.

Preferred polyisocyanates are 2,4- and/or 2,6-diisocyanatotoluene, MDI being very particularly preferred. MDI is used here as a generic term for monomeric 2,4′- and/or 4,4′-diisocyanatodiphenylmethane, and also for the crude phosgenation products of aniline/formaldehyde condensation products containing 10 to 60 wt. % of higher oligomers and having functionalities of 2.1 to 3.0, which are known by the name polymeric MDI. It is also possible to use mixtures of monomeric and polymeric MDI. A further possibility is to use MDI derivatives where, to improve the handling of the monomeric 4,4′-MDI, 4,4′-diisocyanatodiphenylmethane derivatives with isocyanate contents of 28 to 31%, which can be stored as liquids at room temperature, are obtained by the introduction of carbodiimide or allophanate groups. Very particularly preferred MDI grades are those with a monomer content of 70 to 100%, the proportion of 2,4′-MDI preferably being between 10 and 70 wt. %.

In one preferred embodiment, the polyisocyanate a1) consists of diphenymethane diisocyanates containing 10 to 70 wt. % of 2,4′-MDI and 0 to 30 wt. % of oligomers.

Very particularly preferably, the polyisocyanate a1) used is MDI containing 20 to 60 wt. % of 2,4′-MDI and 0 to 30 wt. % of oligomers.

The polyol mixture a2) used according to the invention, with a mean hydroxyl number preferably of 50 to 180 mg KOH/g and particularly preferably of 60 to 150 mg KOH/g, preferably consists of the polyols i) and ii). The polyol mixture a2) preferably contains 20 to 80 wt. % of component i) and 20 to 80 wt. % of component ii), the amounts given being based on the total weight of polyol mixture a2).

Component i) used according to the invention consists of one or more fatty acid triglycerides having one or more hydroxyl groups and a mean hydroxyl number preferably of 100 to 170, particularly preferably of 110 to 150 and very particularly preferably of 110 to 130 mg KOH/g. Particularly suitable triglycerides are those of saturated or unsaturated fatty acids containing hydroxyl groups and having a C number ranging from 8 to 26, preferably from 12 to 22, such as ricinoleic acid, or mixtures thereof with other saturated or unsaturated fatty acids having a C number ranging from 8 to 26, preferably from 12 to 22, and not containing hydroxyl groups, such as, in particular, linoleic, palmitic and/or stearic acid. A preferred triglyceride is castor oil and its derivatives. In the polyol mixture a2) for the preparation of the isocyanate-terminated prepolymers a), component i) is used in an amount preferably of 20 to 80 wt. % and particularly preferably of 40 to 70 wt. %, based on the total amount of polyol mixture a2). Castor oil and castor oil derivatives may be mentioned in particular as fatty acid triglycerides containing hydroxyl groups. The proportion of castor oil of hydroxyl number 160 to 170 mg KOH/g in the polyol i) can expediently be between 0 and 70 and preferably 0 to 50 wt. %. It is very particularly preferable according to the invention to use a monodehydrated castor oil of hydroxyl number 110 to 130 mg KOH/g in an amount of 30 to 100, preferably of 50 to 100 and particularly preferably of 100 wt. % in component i). Such products, which can preferably be used as component i), are essentially prepared by splitting approx. one mol of water from castor oil, whereby a double bond forms and the hydroxyl number decreases from approx. 165 to approx. 120 mg KOH/g. Such products are commercially available. Reference may be made here to e.g. Rizinusöl PD® from Alberdingk & Boley, Krefeld, inter alia.

In the present invention the hydroxyl number is determined according to DIN 53240. According to said DIN 53240, it is the amount of potassium hydroxide, in mg, that is equivalent to the amount of acetic acid which is bound in the acetylation of 1 g of substance.

Particularly suitable polyethers of component ii) having an average of at least two and preferably two to four hydroxyl groups are the commercially available addition products of propylene oxide and/or ethylene oxide and short-chain diols, for example propylene glycol, and/or triols, for example glycerol or trimethylolpropane, or else amines, for example triethanolamine or ethylenediamine. This addition reaction normally takes place under base catalysis, but can also proceed via specific zinc-cobalt double metal complexes (e.g. U.S. Pat. No. 3,829,505). The polyetherpolyols of component ii) expediently have mean hydroxyl numbers of 20 to 200 mg KOH/g, preferably of 25 to 150 mg KOH/g and particularly preferably of 30 to 120 mg KOH/g. Branched polyetherpolyols having an average of three to four hydroxyl groups per molecule are preferred. If the adhesives are used to bond very damp woods, the concomitant use of longer ethylene oxide blocks in the polyetherpolyols is advantageous for ensuring a better wetting of the wood. Polytetramethylene ether polyglycols with hydroxyl numbers of 70 to 130 mg KOH/g are likewise suitable. Of course, it is also possible to use any desired mixtures of such polyhydroxyl compounds.

Particularly preferably, the polyether component in ii) consists of poly(propylene oxide/ethylene oxide) copolymer polyols with an ethylene oxide content of 0 to 30 wt. %, preferably of 0 wt. % to 20 wt. %. The length of the ethylene oxide chain should be between 10 and 20 ethylene oxide units. Longer ethylene oxide units tend to crystallize in the cold and could thus have an adverse effect on the storage stability of the prepolymer in the cold. Polypropylene ether polyols having a mean functionality of three to four and a mean hydroxyl number of 40 to 120 mg KOH/g, such as those obtained by the addition of propylene oxide onto starters like triethanolamine and ethylenediamine, are very particularly preferred. Such a proportionate use already gives the prepolymers a degree of basic reactivity towards moisture.

The polyethers of component ii) have a number-average molecular rate ranging preferably from about 600 to about 6000 and particularly preferably from about 800 to about 5000. Molecular weights outside said range can be disadvantageous because they could increase the viscosity of the prepolymers. The number-average molecular weight (Mₙ) is calculated by the following formula:
Mₙ=(mean functionality Fm×56,100)/mean number of hydroxyl groups

The NCO prepolymer a) is prepared by reacting the polyol mixture a2) with the organic polyisocyanate a1).

In the preparation of the NCO prepolymer a), there are 3 to 30 and preferably 5 to 10 isocyanate groups per isocyanate-reactive group. The proportion of polyol component a2) in the finished NCO prepolymer is between 20 and 75 wt. %, preferably between 30 and 60 wt. %, and the proportion of polyisocyanate component a) is between 80 and 25 wt. %, preferably between 70 and 40 wt. %.

The prepolymers are prepared in normal stirred tank reactors, the polyisocyanate always being introduced first and the polyols being metered in successively or in a mixture at temperatures of 50 to 90° C., optionally under an inert gas atmosphere. The reaction temperature should preferably be between 70 and 90° C. However, the reaction can also be carried out continuously in a reaction tube or a series of stirred tank reactors. Preferably, the reaction is not carried out in the presence of solvents. The reaction is usually over after two to four hours and the prepolymer should have an isocyanate content slightly below the theoretical value.

Preferred prepolymers are obtained with organic polyisocyanates a1) containing 0 to 80 wt. %, preferably 20 to 60 wt. %, of difunctional 2,4′-MDI together with 4,4′-MDI.

In particular, the 2,4′-MDI content contributes to the storage stability of the prepolymers. Of course, it is also possible to use polyisocyanates whose content of oligomeric MDI having a functionality greater than 2 is 5 to 50 and preferably 10 to 30 wt. %. In the component a1), the content of monomeric diphenylmethane diisocyanate, based on the sum of all the MDI products used, should preferably be between 70 and 100 wt. % and the content of 2,4′-diphenyhnethane diisocyanate should be between 0 and 80 and preferably between 10 and 70 wt. %. The content of higher oligomers should be between 0 and 30 wt. %.

In principle, in the preparation of the NCO prepolymers for the use according to the invention, it is possible either (1) directly to use an organic polyisocyanate a1) containing 2,4′-MDI and/or 4,4′-MDI and over 10 to 50 wt. % of higher oligomers, or (II) firstly to carry out the reaction with a monomeric diisocyanate having a 2,4′-MDI content of 40 to 70 wt. % until the NCO content is 8 to 12 wt. %, and then to add a polyisocyanate having an oligomer content of up to 70 wt. %, preferably of up to 50 wt. %, so as to bring the NCO content of the mixture to 14 to 18 wt. %.

The prepolymer prepared according to (II) has a lower viscosity than the prepolymer obtained according to (I).

In principle, these prepolymers containing isocyanate groups can subsequently be treated with polyfunctional aliphatic isocyanates. Such a procedure makes it possible to increase the functionality of the system without the viscosity of the prepolymer increasing as a result. Particularly preferred polyisocyanates in this case are hexamethylene diisocyanate derivatives containing biuret groups or isocyanurate groups, such as, inter alia, those marketed by Bayer AG under the trade names Desmodur N 100 or Desmodur N 3300.

The NCO prepolymers a) prepared in this way are free of fillers and have viscosities preferably of less than 3000 and particularly preferably of less than 2000 mPa·s at 25° C.

The prepolymers according to the invention prepared in this way, containing isocyanate groups, can in principle already be used in this form as adhesives or coating materials.

However, it is not customary to use them in this form; rather, the products are preferably modified for their respective applications.

Modification by the incorporation of specific additives b) is expediently effected in special stirred units that are capable of rapidly and uniformly dispersing small amounts of additives, especially those with a tendency to agglomerate, in the prepolymers. Stirred units with Dissolver disks may be mentioned here in particular. These operations are not all material to the invention and will be described briefly below.

The raw materials of the preceding stage have to be finely adjusted in respect of their reactivity to moisture by the addition of further catalysts. Thus an adhesive for bonding large areas requires a different reactivity from that of an adhesive designed for very small areas. An accelerated reaction with atmospheric moisture can be achieved with the common catalysts conventionally used in polyurethane chemistry, for example tertiary amines such as diazabicyclooctane, dimorpholinodiethyl ether and bis(dimethylaminoethyl) ether, and/or metal catalysts such as dibutyltin dilaurate.

The rheological behaviour of the raw materials a) according to the invention has to be adapted to the subsequent application requirements. Because of low viscosity, for example, the products would run or drip off vertical surfaces.

By the addition of Aerosils, short fibres such as Kevlar pulp, or similar microfibres which have been rendered hydrophobic on the surface, or else by reaction of the prepolymer a) with aliphatic or aromatic polyamines, for example isophoronediamine or diethyltoluylenediamine, in an amount of 0.2 to 5% of the stoichiometric amount, it is possible to convert the low-viscosity prepolymer a) to a highly pseudoplastic form which again becomes easily processable under the influence of shear forces but is otherwise no longer free-flowing on vertical surfaces.

For applications of a more gap-bridging nature, it can be advantageous to add larger amounts of anhydrous fillers.

Other possible modifications are the addition of natural or synthetic resins to increase the initial strength, ageing stabilizers, or pigments, dyestuffs or similar additives so that the application can easily be checked visually for uniformity, etc.

The proportion in the composition of these auxiliary substances and additives b) conventionally used for adhesives is at most about 30 wt. %, preferably at most about 10 wt. %, based on the total amount of composition. Accordingly, the proportion of isocyanate-terminated prepolymer in the composition used according to the invention is preferably from 70 to 100 wt. %, particularly preferably from 90 to 100 wt. %, based on the total amount of composition.

The composition used according to the invention also preferably contains substantially no organic solvents. In terms of the invention, “substantially no organic solvents” means preferably less than 5 wt. %, particularly preferably less than 3 wt. %, very particularly preferably less than 1 wt. % and usually preferably 0 wt. %, i.e. no organic solvents, the amounts given being based in each case on the total amount of composition.

According to the invention the composition is used as a coating material and adhesive, especially as an adhesive for bonding wood substrates. In terms of the invention and according to DIN 16920, June 1981, an adhesive is a non-metallic substance that joins base parts by surface adhesion and internal strength (cohesion). Wood substrates which can be adhesively bonded according to the invention are especially load-bearing wood structural members. The wood substrates can consist of any possible types of wood, for example maple, apple, birch, pear, beech, Douglas fir, yew, oak, serviceberry, alder, ash, spruce, hombeam, pine, cherry, larch, lime, walnut, poplar, plane, robinia, horse chestnut, red birch, elm, Swiss pear, fir, elm, willow and plum, as well as goldteak, aningeria, stone pine, bete, bubinga, ebony, hickory, iroko, kambala, kevazingo, limba, mahogany, Macassar ebony, makore, mansonia, meranti, bog oak, mutenye, myrtle, olive ash, Oregon pine, padouk, jacaranda, East Indian jacaranda, rio, red cedar, redwood, sycamore maple, giant arborvitae, sapelli (mahogany), sequoia, sen, sucupira, tchitola, teak, birdseye maple, wenge and zebrano. Beech, spruce, larch, Douglas fir, pine and robinia are preferred.

The invention further relates to a process for the production of adhesively bonded wood substrates, comprising the application of the composition used according to the invention to at least one wood substrate in an amount of 100 to 500 g/m², preferably of 150 to 350 g/m², the subsequent joining of this wood substrate to at least one other wood substrate that is optionally also coated with the composition used according to the invention, and the subsequent hardening of the joined wood substrates, optionally with the application of a pressure e.g. of up to 0.5 to 1.0 N/mm² in the case of surface gluing or 2 to 15 N/mm² in the case of dovetail gluing. Finally, the invention further relates to the adhesively bonded wood substrates obtainable by the process described above.

Of course, it is also possible to adhesively bond other materials, for example mineral wool or insulating foams made of polyurethane, polystyrene, etc., to facings such as aluminium, steel or wood. In all non-wood applications, however, care must be taken to ensure that sufficient moisture is available for hardening, it being possible, if necessary, to supply additional moisture in the form of mist or water spray.

The invention is illustrated more precisely by means of the Examples which follow. Those skilled in the art are aware of the fact that the scope of the present invention is not restricted to these Examples.

### EXAMPLES

Preparation of the Prepolymers

The polyisocyanates are introduced at 70° C. and the dehydrated polyols (water content <0.05%) are added so as to keep the temperature in the range between 60 and 80° C.

Polyols

| | |
|---|---|
| Polyol I | Rizinusöl PD (Alberdingk & Boley) of OH number 122 mg |
| | KOH/g; mean functionality approx. 2. |
| Polyol II | Desmophen ® 5034 BT (Bayer MaterialScience AG, |
| | Leverkusen): polypropylene ether polyol of OH number |
| | 35 mg KOH/g; glycerol starter; ethylene oxide content |
| | approx. 14 wt. %; mean functionality approx. 2.85. |
| Polyol III | Desmophen ® 2060 BD (Bayer MaterialScience AG, |
| | Leverkusen): polypropylene ether glycol of OH number |
| | 56 mg KOH/g; mean functionality approx. 1.96. |
| Polyol IV | Castor oil of OH number 166 mg KOH/g; mean functionality |
| | approx. 2.9. |
| Polyol V | Desmophen ® 4059 EV (Bayer MaterialScience AG, |
| | Leverkusen): polypropylene ether polyol of OH number |
| | 60 mg KOH/g; ethylenediamine starter; mean functionality |
| | approx. 3.7. |

Polyisocyanates

| | |
|---|---|
| Iso I | Desmodur ® 2460 M (Bayer MaterialScience AG, |
| | Leverkusen) (monomeric MDI): mixture of 54.5 wt. % |
| | of 2,4′-MDI and 45.4 wt. % of 4,4′-MDI. |
| Iso II | Desmodur ® VKS 20 F (Bayer MaterialScience AG, |
| | Leverkusen) (polymeric MDI) with an NCO content |
| | of 31.5% and a polymer content of approx. 50 wt. %. |

### Example 1

### According to the Invention

562 g of Iso I are introduced and heated to 70° C. 219 g of Polyol III are added rapidly under a nitrogen atmosphere, with stirring, and 219 g of Polyol I are then added dropwise. When the exothermic reaction has subsided, the reaction is brought to completion over 4 hours at 80° C. This gives an NCO prepolymer with an NCO content of 15.8% and a viscosity of 1100 mPa·s at 25° C.

### Example 2

### According to the Invention

576 g of Iso I are introduced and heated to 70° C. 106 g of Polyol III are added rapidly under a nitrogen atmosphere, with stirring, and 318 g of Polyol I are then added dropwise. When the exothermic reaction has subsided, the reaction is brought to completion over 4 hours at 80° C. This gives an NCO prepolymer with an NCO content of 15.7% and a viscosity of 985 mPa·s at 25° C.

### Example 3

### According to the Invention

549 g of Iso I are introduced and heated to 70° C. 338 g of Polyol III are added rapidly under a nitrogen atmosphere, with stirring, and 113 g of Polyol I are then added dropwise. When the exothermic reaction has subsided, the reaction is brought to completion over 4 hours at 80° C. This gives an NCO prepolymer with an NCO content of 15.7% and a viscosity of 890 mPa·s at 25° C.

### Example 4

### Less Preferred

586 g of Iso I are introduced and heated to 70° C. 208 g of Polyol III are added rapidly under a nitrogen atmosphere, with stirring, and 208 g of Polyol IV are then added dropwise. When the exothermic reaction has subsided, the reaction is brought to completion over 4 hours at 80° C. This gives an NCO prepolymer with an NCO content of 16.1% and a viscosity of 4450 mPa·s at 25° C.

### Example 5

### Comparative

550 g of Iso I are introduced and heated to 70° C. 225 g of Polyol III are added rapidly under a nitrogen atmosphere, with stirring, and 225 g of Polyol II are then added dropwise. When the exothermic reaction has subsided, the reaction is brought to completion over 4 hours at 80° C. This gives an NCO prepolymer with an NCO content of 15.9% and a viscosity of 910 mPa·s at 25° C.

### Example 6

### According to the Invention

554 g of Iso I are introduced and heated to 70° C. 223 g of Polyol II are added rapidly under a nitrogen atmosphere, with stirring, and 223 g of Polyol I are then added dropwise. When the exothermic reaction has subsided, the reaction is brought to completion over 4 hours at 80° C. This gives an NCO prepolymer with an NCO content of 16.1% and a viscosity of 1550 mPa·s at 25° C.

### Example 7

### According to the Invention

299 g of Iso 1 and 279 g of Iso III are introduced and heated to 70° C. 211 g of Polyol II are added rapidly under a nitrogen atmosphere, with stirring, and 211 g of Polyol I are then added dropwise. When the exothermic reaction has subsided, the reaction is brought to completion over 4 hours at 80° C. This gives an NCO prepolymer with an NCO content of 15.7% and a viscosity of 3380 mPa·s at 25° C.

### Example 8

### According to the Invention

229 g of Iso I are introduced and heated to 70° C. 211 g of Polyol II are added rapidly under a nitrogen atmosphere, with stirring, and 211 g of Polyol I are then added dropwise. After 20 minutes, 279 g of Iso II are added. The reaction is brought to completion over 4 hours at 80° C. This gives an NCO prepolymer with an NCO content of 15.6% and a viscosity of 2950 mPa·s at 25° C.

### Example 9

### According to the Invention

565.1 g of Iso I are introduced and heated to 70° C. 217.5 g of Polyol I are added rapidly under a nitrogen atmosphere, with stirring, and 217.5 g of Polyol V are then added dropwise. After 20 minutes, 279 g of Iso II are added. The reaction is brought to completion over 4 hours at 80° C. This gives an NCO prepolymer with an NCO content of 15.92% and a viscosity of 1670 mPa·s at 25° C.

### Example 10

### According to the Invention

563 g of Iso I are introduced and heated to 70° C. 109.2 g of Polyol I are added rapidly under a nitrogen atmosphere, with stirring, and 109.5 g of Polyol IV and 218.5 g of polyol II are then added dropwise. After 20 minutes, 279 g of Iso II are added. The reaction is brought to completion over 4 hours at 80° C. This gives an NCO prepolymer with an NCO content of 15.71% and a viscosity of 1840 mPa·s at 25° C.

Adhesive Bonding of Wood

Beechwood test pieces of dimensions 20×40×5 mm are brush-coated with the prepolymers (amount applied approx. 100 to 300 g/m²), with an overlap of 20 mm, and, without gaps, left in a press under a pressure of 0.6 N/mm² for 24 hours at room temperature.

After storage for 14 days at 23° C. and 50% RH, the test pieces are broken apart dry in the tension shear test; after storage in water for 24 hours (23° C.), they are broken apart damp.

The following results were obtained:

Test Results

| Type of test | Dry storage | Damp storage |
|---|---|---|
| Result | N/mm²/% BPF | N/mm²/% BPF |
| Example 1 | 11.7/100 | 8.9/100 |
| Example 2 | 12.3/90 | 8.1/80 |
| Example 3 | 11.5/80 | 6.9/50 |
| Example 4 | 10.8/80 | 7.8/70 |
| Example 5 (comparative) | 10.9/30 | 5.4/0 |
| Example 6 | 11.6/90 | 8.7/90 |
| Example 7 | 10.6/100 | 8.2/80 |
| Example 8 | 11.9/100 | 8.6/90 |
| Example 9 | 11.9/100 | 7.6/90 |
| Example 10 | 10.2/90 | 7.2/80 |

N/mm²: adhesive strength in the tension shear test at a speed of advance of 50 mm/min
BPF: base part failure in % of adhesively bonded area

The Table shows that the NCO prepolymers according to the invention (Examples 1, 2, 3, 4, 6, 7 and 8) have on average a high base part failure after storage in water. Example 4 likewise shows an appreciable base part failure, although the viscosity of approx. 4500 mPa·s is very high and would make processing very difficult under practical conditions on formulation with fillers, catalysts, dyestuffs and rheology processing aids, because the viscosity increases further in practice.

The prepolymer of Example 5, not according to the invention, exhibits a markedly poorer behaviour in the water storage test.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition for the manufacture of coating materials and/or adhesives, comprising:
a) at least one isocyanate-terminated prepolymer obtained by reacting
a1) at least one organic polyisocyanate and
a2) a mixture of at least two organic polyhydroxyl compounds containing:
i) at least 20 wt. % of fatty acid triglycerides containing hydroxyl groups, and
ii) at least 20 wt. % of polyethers having an average of at least two hydroxyl groups,
the amounts given for i) and ii) being based on the total amount of mixture a2), and
b) optionally auxiliary substances and additives.

2. The composition according to claim 1, wherein the mixture a2) has a mean hydroxyl number of 50 to 180 mg KOH/g.

3. The composition according to claim 1, wherein the isocyanate content of the prepolymer a) is between 8 and 20 wt. %.

4. The composition according to claim 1, wherein the isocyanate content of the prepolymer a) is between 8 and 18 wt. %.

5. The composition according to claim 1, wherein the polyisocyanate a1) used consists of diphenylmethane diisocyanates containing 10 to 70 wt. % of 2,4′-MDI and 0 to 30 wt. % of oligomers.

6. The composition according to claim 1, wherein the fatty acid triglycerides a2) i) containing hydroxyl groups have a mean hydroxyl number of 100 to 170 mg KOH/g.

7. The composition according to claim 6, wherein the fatty acid triglycerides a2) i) containing hydroxyl groups have a mean hydroxyl number of 110 to 130 mg KOH/g.

8. The composition according to claim 1, wherein the fatty acid triglycerides a2) i) containing hydroxyl groups are substantially monodehydrated castor oil with a hydroxyl number of 110 to 130 mg KOH/g.

9. The composition according to claim 1, wherein the polyetherpolyol ii) in the mixture a2) has a hydroxyl number of 20 to 200 mg KOH/g.

10. The composition according to claim 1, wherein the polyetherpolyol ii) in the mixture a2) consists essentially of polypropylene ether polyols containing glycerol, trimethylolpropane, triethanolamine and/or ethylene-diamine as starters, the molecular weight of the polyetherpolyol ii) ranging from 800 to 6000.

11. The composition according to claim 1, wherein the content of component i) in the polyol mixture a2) is 40 to 70 wt. %, based on the total amount of polyol mixture a2).

12. The composition according to claim 1, wherein the polyether component in ii) consists of poly(propylene oxide/ethylene oxide) copolymer polyols with an ethylene oxide content of 0 to 20 wt. %.

13. An adhesive for bonding wood substrates comprising the composition according to claim 1.

14. The composition according to claim 1, for use in the adhesive bonding of wood substrates.

15. Process for the production of adhesively bonded wood substrates, comprising applying the composition according to claim 1 to at least one first wood substrate, subsequently joining the first wood substrate to at least one second wood substrate that is optionally also coated with the composition according to claim 1, and subsequently hardening the joined wood substrates, optionally with the application of pressure.

16. Adhesively bonded wood substrates obtained by the process according to claim 15.
